(19) United States
(12) Patent Application Publication
(10) Pub. No.: US 2019/0349269 A1
(43) Pub. Date: Nov. 14, 2019

(54) METHOD, SYSTEM AND DEVICE FOR ONLINE CHARGING IN CLOUD SYSTEM

(71) Applicant: Alcatel Lucent, Nozay (FR)

(72) Inventor: Xiangyang LI, Shanghai (CN)

(73) Assignee: Alcatel Lucent, Nozay (FR)

(21) Appl. No.: 16/306,625

(22) PCT Filed: Jun. 5, 2017
(86) PCT No.: PCT/IB2017/000845

§ 371 Date: Dec. 3, 2018

(30) Foreign Application Priority Data
Jun. 6, 2016 (CN) 201610394503.0

(51) Int. Cl. H04L 12/24; H04L 29/08; H04L 12/26; H04L 12/14; G06Q 30/02

(52) U.S. Cl. CPC H04L 41/5029; H04L 67/10; G06Q 30/0283; H04L 67/306; H04L 12/14; H04L 43/08

(57) ABSTRACT

Embodiments of the present disclosure relate to a method, system and device for online charging in a cloud system. The method comprising: in response to a request for a cloud service in the cloud system from a user, transmitting to an online charging system of the cloud system a message indicating the user and the cloud service; receiving from the online charging system a quota related to the cloud service, the quota indicating a limit for the user to use the cloud service; and providing the cloud service to the user based on the quota. The embodiments of the present disclosure overcome defects of postpaid cloud service charging and billing-based scheme in traditional solutions, and can implement cloud service charging of any type.

### FIELD

The present disclosure generally relates to the technology of cloud computing, and more particularly, to a method, system and device for online charging in a cloud system.

### BACKGROUND

Cloud computing is a representative technology of an important transition and a paradigm shift in service-oriented computing technology. The cloud computing technology allows scalable on-demand sharing of resources and costs among a large number of end users. Emerging could services have become very popular in recent years. Many users, from the individual users, enterprises to government agents, are moving their applications to cloud environment.

For a successful cloud service deployment, besides providing an excellent and rich cloud service to a user, an efficient and flexible cloud service billing and charging are becoming a more and more important role. Charging is one of the most important metrics that a service provider can control to encourage the usage of its services. A flexible and precise charging not only influences revenue of cloud service providers but also impacts cloud customers' budget. A cloud computing provider's typical goal is to maximize its revenue with its employed pricing scheme, while its customers' main goal is to obtain the highest level of quality of service (QoS) feasible for a reasonable price.

Currently, most cloud service providers (CSP) mainly provide cloud service charging and billing in an offline and postpaid mode. A customer uses a cloud service as needed, and is billed by a cloud service provider for the amount of the used cloud service by the end of an agreed-upon period. However, the postpaid charging scheme has disadvantageous and risks for both the operator and the user.

### SUMMARY

Embodiments of the present disclosure provide a method, system and device for online charging in a cloud system.

According to a first aspect of the present disclosure, a method implemented in a cloud system is provided. The method includes: in response to a request for a cloud service in the cloud system from a user, transmitting to an online charging system of the cloud system a message indicating the user and the cloud service; receiving from the online charging system a quota related to the cloud service, the quota indicating a limit for the user to use the cloud service; and providing the cloud service to the user based on the quota.

In some embodiments, the method may further include: monitoring use status of the cloud service for the user while the user is using the cloud service; and transmitting the use status to the online charging system.

In some embodiments, the method may further include: in response to the quota being exhausted, determining that the user requests for continuing to use the cloud service; and in response to determining that the user requests for continuing to use the cloud service, transmitting to the online charging system a request for an additional quota for the cloud service.

In some embodiments, the method may further include: in response to receiving from the online charging system an indication that a balance in an account of the user is insufficient for continuing to use the cloud service, ceasing the providing of the cloud service to the user.

In some embodiments, the method may further include: in response to requesting for changing a parameter related to the cloud service by the user, transmitting a message to the online charging system to instruct the online charging system to reserve a charge for the change in an account of the user.

In some embodiments, the method may further include: in response to the parameter related to the cloud service being changed, transmitting to the online charging system a message indicating that the parameter has been changed; receiving from the online charging system a new quota related to the cloud service with the changed parameter; and providing the cloud service to the user based on the new quota.

In some embodiments, the method may further include: in response to the parameter being unchanged, transmitting to the online charging system a message indicating that the cloud service is unchanged; and continuing to provide the unchanged cloud service to the user.

In some embodiments, the method may further include: transmitting to the online charging system a scaling request for scaling a capability of the cloud service, based on a load of using the cloud service by the user; in response to receiving from the online charging system a positive response to the scaling request, scaling the capability of the cloud service; receiving from the online charging system a new quota related to the scaled cloud service; and providing the scaled cloud service to the user based on the new quota.

In some embodiments, the method may further include: in response to receiving from the online charging system a negative response to the scaling request, maintaining the capability of the cloud service unchanged.

In some embodiments, the method may further include: in response to a service on-boarding request indicating that the user intends to use the cloud service, transmitting to the online charging system an indication of charging an on-boarding charge; if a positive response indicating that the on-boarding charge has been charged is received from the online charging system, allowing the user to use the cloud system; and if a negative response indicating that the on-boarding charge has not been charged is received from the online charging system, declining the user to use the cloud system.

In some embodiments, the cloud service may correspond to at least one service catalog with a service characteristic and a service price, the service characteristic referring to at least one service type in the service catalog and a supply amount thereof.

In some embodiments, transmitting to the online charging system of the cloud system the message indicating the user and the cloud service may include: transmitting to the online charging system a service catalog corresponding to the cloud service.

In some embodiments, the method may further include: transmitting to the online charging system an attribute specific to a certain service catalog and an attribute common to all service catalogs.

In some embodiments, the cloud service may include at least one of the following service layers: an infrastructure as a service (IaaS) layer, a platform as a service (PaaS) layer, a software as a service (SaaS) layer, or a database as a service (DBaaS) layer.

In some embodiments, the method may further include: communicating with the online charging system via a DIAMETER online charging interface or an HTTP/XML REST online charging interface.

According to a second aspect of the present disclosure, another method implemented in a cloud system is provided. The method includes: receiving from a cloud management system of the cloud system a message indicating a user and a cloud service; determining a quota related to the cloud service based on a price of the cloud service and a balance in an account of the user, the quota indicating a limit for the user to use the cloud service; and transmitting the quota to the cloud management system.

In some embodiments, the method may further include: receiving from the cloud management system use status of the cloud service for the user while the user is using the cloud service; determining a charge for the cloud service used by the user based on a price of the cloud service and the use status; and updating the balance in the account of the user based on the determined charge.

In some embodiments, the method may further include: receiving from the cloud management system a request for an additional quota for the cloud service; determining the additional quota based on the price of the cloud service and the updated balance in the account of the user; and transmitting the additional quota to the cloud management system.

In some embodiments, the method may further include: transmitting to the user the charge and the updated balance in the account.

In some embodiments, the method may further include: determining that the balance in the account of the user is insufficient for continuing to use the cloud service; and transmitting to the cloud management system an indication that the balance in the account of the user is insufficient for continuing to use the cloud service.

In some embodiments, the method may further include: in response to receiving from the cloud management system a message indicating that a charge for changing a parameter related to the cloud service is to be reserved in an account of the user, reserving the charge in the account of the user.

In some embodiments, the method may further include: in response to receiving from the cloud management system a message indicating that the parameter has been changed, deducting the reserved charge from the account of the user; determining a new quota related to the cloud service with the changed parameters, based on a price of the cloud service with changed parameters and the balance in the account of the user; and transmitting the new quota to the cloud management system.

In some embodiments, the method may further include: in response to receiving from the cloud management system a message indicating that the cloud service has not been changed, returning the reserved charge to the account of the user.

In some embodiments, the method may further include: in response to receiving from the cloud management system a scaling request for scaling a capability of the cloud service, determining whether the scaling request is approved or declined based on the balance in the account of the user; if the balance in the account of the user is sufficient for the scaling, transmitting to the cloud management system a positive response to the scaling request; determining a new quota related to the scaled cloud service based on a price of the scaled cloud service and the balance in the account of the user; and transmitting the new quota to the cloud management system.

In some embodiments, the method may further include: if the balance in the account of the user is insufficient for the scaling, transmitting to the cloud management system a negative response to the scaling request.

In some embodiments, the method may further include: in response to receiving from the cloud management system an indication of charging an on-boarding charge, charging the on-boarding charge from the account of the user; if the charging is successful, transmitting to the cloud management system a positive response indicating that the on-boarding charge has been charged; and if the charging is unsuccessful, transmitting to the cloud management system a negative response indicating that the on-boarding charge has not been charged.

In some embodiments, the cloud service may correspond to at least one service catalog with a service characteristic and a service price, the service characteristic referring to a service type in the service catalog and a supply amount thereof.

In some embodiments, receiving from the cloud management system of the cloud system the message indicating the user and the cloud service may include: receiving from the cloud management a service catalog corresponding to the cloud service; and determining the price of the cloud service based on the service price of the service catalog.

In some embodiments, the method may further include: receiving from the cloud management system an attribute specific to a certain service catalog and an attribute common to all service catalogs for use in determining the price of the cloud service.

In some embodiments, the method may further include: determining the price of the cloud service based on at least one of a tariff plan, a bucket usage amount, a bundle price, a counter price, a discount price, a peak hour price or an off-peak hour price.

In some embodiments, the cloud service may include at least one of the following service layers: an infrastructure as a service (IaaS) layer, a platform as a service (PaaS) layer, a software as a service (SaaS) layer, or a database as a service (DBaaS) layer.

In some embodiments, the method may further include: communicating with the cloud management system via a DIAMETER online charging interface or an HTTP/XML REST online charging interface.

According to a third aspect of the present disclosure, a cloud system is provided. The cloud system includes a cloud management system configured to perform the method according to the first aspect of the present disclosure; and an online charging system configured to perform the method according to the second aspect of the present disclosure.

In some embodiments, the cloud management system may communicate with the online charging system via a DIAMETER online charging interface.

In some embodiments, the cloud management system may communicate with the online charging system via an HTTP/XML REST online charging interface.

According to a fourth aspect of the present disclosure, a cloud management system of a cloud system is provided. The cloud management system includes a memory and a processor, the memory being configured with the process to cause the cloud management system to perform the method according to the first aspect of the present disclosure.

According to a fifth aspect of the present disclosure, an online charging system of a cloud system is provided. The online charging system includes a memory and a processor, the memory being configured with the processor to cause the online charging system to perform the method according to the second aspect of the present disclosure.

The embodiments of the present disclosure provide a real-time online charging solution for various cloud services. This charging mode enables the online charging system to real-timely authorize and monitor use of the cloud service based on a balance in the user's account. The real-time online charging control avoids the issue that a bill is beyond an expectation of the user, and enables the user to real-timely know use status of the cloud service and the charge. The embodiments of the present disclosure also enable the telecommunication providers to extend current telecommunication based online charging solutions to an Internet Technology based cloud service, and may implement a common charging platform to charge various services including telecommunication services and cloud services.

To sum up, the embodiments of the present disclosure overcome defects of the postpaid cloud service charging and billing-based scheme in the traditional solutions, and can implement cloud service charging of any type.

### BRIEF DESCRIPTION OF THE DRAWINGS

Through the following detailed description with reference to the accompanying drawings, the above and other objectives, features, and advantages of example embodiments of the present disclosure will become more apparent. Several example embodiments of the present disclosure will be illustrated by way of example but not limitation in the drawings in which:

FIG. 1 is a diagram schematically illustrating an environment of a cloud system in which embodiments of the present disclosure may be implemented.

FIG. 2 is a flowchart schematically illustrating a method implemented in a cloud system according to one embodiment of the present disclosure.

FIG. 3 is a flowchart schematically illustrating a method implemented in a cloud system according to another embodiment of the present disclosure.

FIG. 4 is a diagram schematically illustrating that a cloud management system and an online charging system operate and interact, with a service catalog, according to embodiments of the present disclosure.

FIG. 5 is a diagram schematically illustrating that the cloud management system transmits information related to a cloud service to the online charging system, and the online charging system performs charging based on various factors, according to embodiments of the present disclosure.

FIG. 6 is a diagram schematically illustrating the cloud management system and the online charging system according to embodiments of the present disclosure in the case of scaling the cloud service.

FIG. 7 is a diagram schematically illustrating an attribute value pair (AVP) of a DIAMETER online charging interface according to embodiments of the present disclosure.

FIG. 8 is a diagram schematically illustrating interaction between the cloud management system and the online charging system according to embodiments of the present disclosure.

FIG. 9 is a block diagram schematically illustrating the cloud management system of the cloud system according to embodiments of the present disclosure.

FIG. 10 is a block diagram schematically illustrating the online charging system of the cloud system according to embodiments of the present disclosure.

Throughout all the drawings, identical or similar reference numbers are used to indicate identical or similar elements.

### DETAILED DESCRIPTION OF EMBODIMENTS

Principles of example embodiments disclosed herein will now be described with reference to various example embodiments illustrated in the drawings. It should be appreciated that description of those embodiments is merely to enable those skilled in the art to better understand and further implement example embodiments disclosed herein and is not intended for limiting the scope disclosed herein in any manner.

As mentioned above, currently, most cloud service providers mainly provide cloud service charging and billing in an offline and postpaid mode. In this mode, a user uses a cloud service as needed, and is billed by a cloud service provider for the amount of the used cloud service by the end of an agreed-upon period. One problem of this charging mode is that the user has no way to control the use of the cloud service in real time and may receive a huge bill at the end of a billing cycle. Therefore, the user may often worry about using the cloud service over a reasonable amount and has an uneasy-of-mind to use the cloud service.

In addition, most telecommunication operators are actively shifting traditional services to a cloud-based platform. With the cloud platform, a user can have more cloud services other than the current telecommunication services. At present, prepaid and postpaid convergent online charging solutions are already widely used in the telecommunication services. Therefore, there is a strong need from the users that an online charging solution for the cloud service is also supported.

In view of the above defects in the traditional solutions, embodiments of the present disclosure provide a method implemented in a cloud system, a cloud system, a cloud management system of a cloud system, and an online charging system of a cloud system, so as to solve technical problems in the traditional solutions.

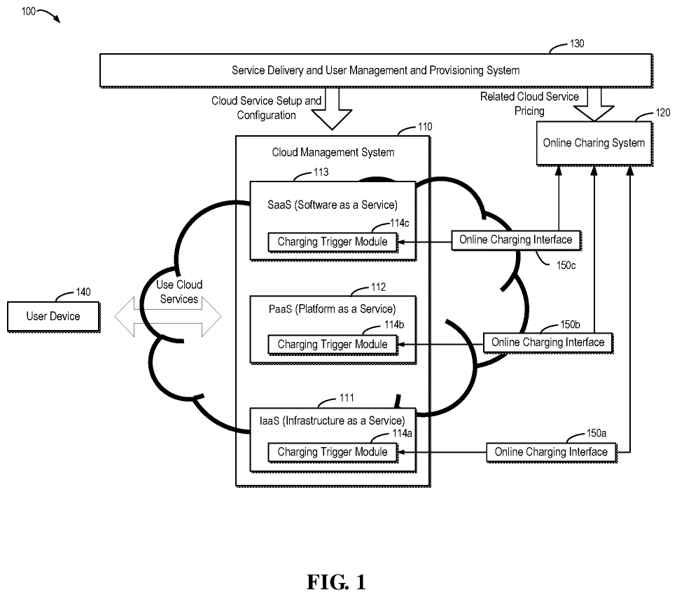

FIG. 1 is a diagram schematically illustrating an environment of a cloud system 100 in which embodiments of the present disclosure may be implemented. As shown in FIG. 1, the cloud system 100 may include a cloud management system 110, an online charging system 120, a service delivery and user management and provisioning system 130, a user device 140, and online charging interfaces 150a, 150b and 150c, which are collectively called online charging interfaces 150.

The cloud management system 110 may include a Software as a Service (SaaS) layer 111, a Platform as a Service (PaaS) layer 112 and an Infrastructure as a Service (IaaS) layer 113. Although FIG. 1 only depicts three service layers, the cloud management system 110 may include more or fewer service layers in other embodiments. In particular, the SaaS layer 111, PaaS layer 112 and IaaS layer 113 may respectively include charging trigger modules or also called charging trigger points 114a, 114b and 114c. The charging trigger modules 114a, 114b and 114c are collectively called charging trigger modules 114.

It is noted that although FIG. 1 depicts that each service layer includes one charging trigger module, but in other embodiments, each service layer may include more or fewer charging trigger modules and some service layers may not include a charging trigger module. Correspondingly, in some embodiments, the cloud management system 110 may communicate with the online charging system 120 via more or fewer online charging interfaces 150.

A user may use the cloud service provided by the cloud system 100 via the user device 140. For example, the user device 140 may include or run a WEB browser, a mobile APP, a thin client, and a terminal simulator, etc. The charging trigger modules 114a, 114b and 114c of the cloud management system 110 may communicate with the online charging system 120 via the online charging interfaces 150a, 150b and 150c, respectively, so as to implement a control operation on the use of the cloud service by the user based on a service charge. In order to achieve this purpose, the service delivery and user management and provisioning system 130 may provide cloud service establishing and configuring information and related cloud service price information to the cloud management system 110 and the online charging system 120, respectively.

When the user intends to use the cloud service provided by the cloud system 100 via the user device 140, the charging trigger modules 114 of the cloud management system 110 may send a message indicating the user and the cloud service to the online charging system 120 via the online charging interfaces 150. The online charging system 120 may determine a quota for the user to use the cloud service based on related information of the user and the cloud service (e.g. a balance in an account of the user and a price of the cloud service, etc.), and transmit the quota via the online charging interfaces 150 to the charging trigger modules 114 of the cloud management system 110. Thereby, the cloud management system 110 may provide the cloud service to the user based on the quota. By providing the cloud service to the user in a manner of quota, the charge for the cloud service used by the user will not go beyond the user's expectation.

In addition, while the user is using the cloud service via the user device 140, the charging trigger modules 114 may monitor use status of the cloud service for the user, and transmit the use status via the online charging interfaces 150 to the online charging system 120. The online charging system 120 may determine the charge for the cloud service used by the user based on the use status, and update the balance in the account of the user accordingly. Therefore, embodiments of the present disclosure may charge the cloud service used by the user in real time, and thus may improve the postpaid manner in the traditional solutions.

Additionally, the online charging solution according to embodiments of the present disclosure may provide various cloud computing services at different service layers, including online charging for the IaaS layer 111, online charging for the PaaS layer 112, and online charging for the SaaS layer 113, etc.

The IaaS layer 111 provides a virtual infrastructure service with different computing/storage/network capability configuration, and it also offers additional resources such as a virtual machine, a server, a disk-image library, a block/object storage, a firewall, a load balancer, an Internet Protocol (IP) address, a Virtual Local Area Network (VLAN), etc. The embodiments of the present disclosure enable online charging the utility computing basis to real-timely reflect an amount of the allocated and consumed infrastructure resources, like computing storage, network, etc.

In the online charging for the IaaS layer 111, the embodiments of the present disclosure may charge services with different resource configurations. Taking a virtual machine (VM) as an example, the resources may include a processor, a memory, a storage device, etc. Alternatively or additionally, the embodiments of the present disclosure may real-timely charge for a storage volume, an input/output (IO) operation, and an amount of transferred data provided by a data center. The embodiments of the present disclosure may real-timely charge for network resources and network services, such as a load balance serving time, a load balance processed data amount, a number of additional elastic IP addresses besides a standard configuration, and a routing policy transaction throughput, etc.

The PaaS layer 112 offers a computing platform which typically includes an operating system, a programming-language execution environment, an execution runtime, a database, a web server, development, analytics, an Internet of Things (IoT), a Content Distribution Network (CDN), security and identity, etc.

In the online charging for the PaaS layer 112, the embodiments of the present disclosure may online charge for cloud computing platform usage with different platform configurations having additional software packages and additional services. For example, the real-time charging is performed based on operating system options, such as UNIX, Linux, Windows, MAC OS, etc.; the real-time charging is performed based on additional software packages, for example, different database engines, such as MS SQL, MySQL, PostgreSQL, etc.; and the real-time charging is performed based on specific platform configuration settings.

The SaaS layer 113 directly provides to the user a software application with simplified maintenance and support and eliminates a need to install and run the application on the cloud user's own computer(s). A typical SaaS service is a service like a Customer Relationship Management (CRM) application, a web email application, a virtual desktop application, a computation application, a communication application, a calendar application, a picture application, etc.

In the online charging for the SaaS layer 113, embodiments of the present disclosure enable online charging for the SaaS based on usage per subscription fee, or usage charge per bundle, and after the bundle usage, an additional service will be charged with an overage rate, etc.

The embodiments of the present application may also support different service charging models based on a characteristic of a specific service catalog. For example, session-based charging based on a usage amount is supported, such as charging based on a cloud resource usage time duration (e.g. a number of hours), and event-based charging for one-shot service is supported (e.g. service on-boarding, and changing a specific service configuration, etc.).

Embodiments of the present disclosure may also support recurring cloud service charging and non-recurring cloud service charging. In the case of recurring cloud service charging, the user will periodically pay the charge for each cloud service catalog. In the case of non-recurring cloud service charging, the user may pay one-shot charge for each cloud service catalog. By using this charging manner, embodiments of the present disclosure may not need an online charging interface with the online charging system 120, because the online charging system 120 may manage the user's balance. When the balance is not enough to fund the recurring cloud service charging and the non-recurring cloud service charging, the online charging system 120 may trigger a related notification to the cloud management system 110. When the balance of the user reaches or resets a balance threshold, or recharges, etc., the cloud management system 110 may activate or deactivate the cloud service accordingly, for example, deactivate a certain cloud service due to exhaustion of the balance.

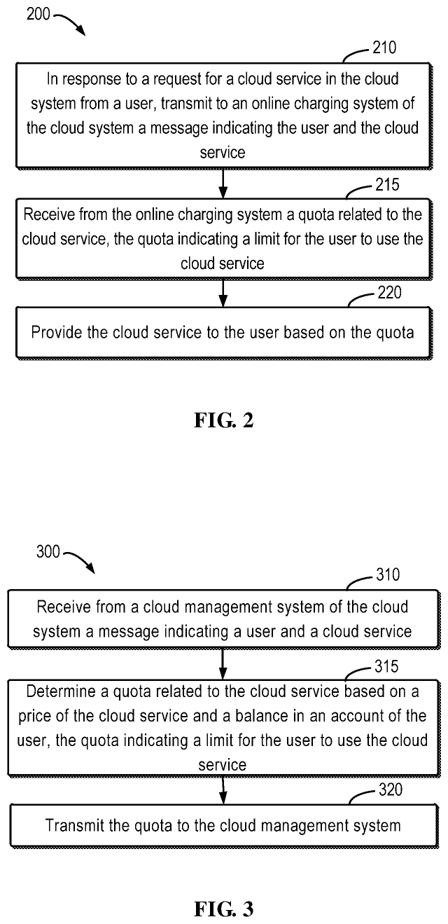

Basic conceptions of the present disclosure are described above briefly referring to FIG. 1. Several embodiments of the present disclosure are detailed below. FIG. 2 is a flowchart schematically illustrating a method 200 implemented in a cloud system according to one embodiment of the present disclosure. In some embodiments, the method 200 may be performed by the cloud management system 110 as depicted in FIG. 1. The method 200 will be specifically described below mainly referring to the cloud system 100 in FIG. 1.

As shown in FIG. 2, in a step 210, in response to a request for a cloud service in the cloud system 100 from the user, the cloud management system 100 sends a message indicating the user and the cloud service to the online charging system 120 of the cloud system 100. Thereby, the online charging system 120 may determine a quota for the user to use the cloud service based on related information, like tariff information of the user and cloud service price information.

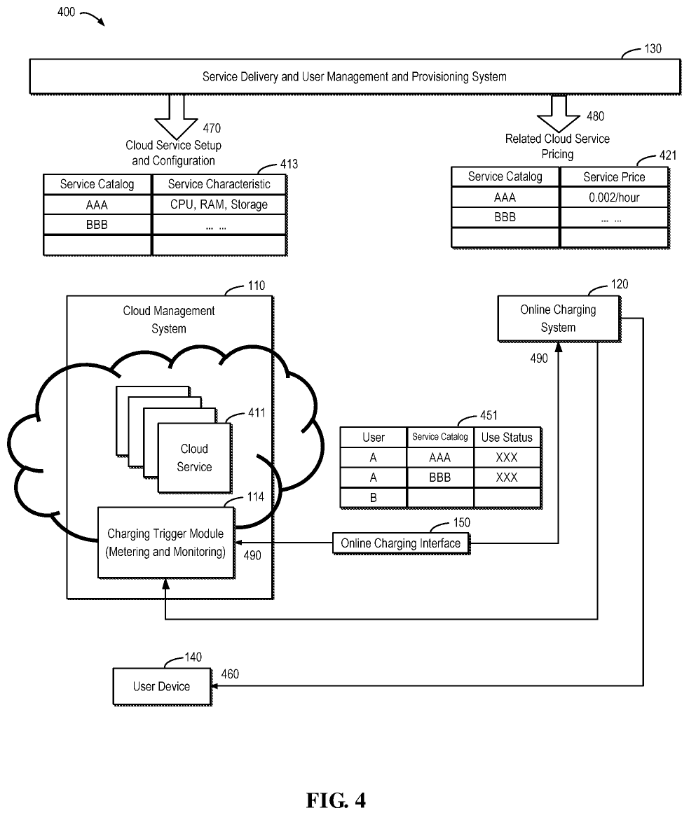

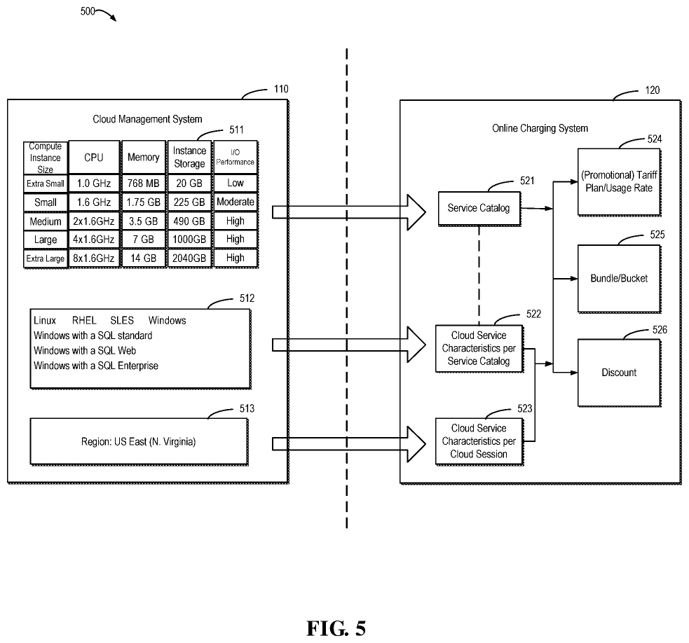

In some embodiments, the cloud service may correspond to at least one service catalog which may have a service price and a service characteristic that may refer to at least one service type in the service catalog and a supply amount thereof. Hereinafter, operations related to the service catalog according to embodiments of the present disclosure will be further described referring to FIG. 4. In the case that the cloud management system 110 communicates with online charging system 120 based on the service catalog, in the step 210 of the method 200, the cloud management system 110 may transmit to the online charging system 120 the service catalog corresponding to the cloud service. Moreover, the cloud management system 110 may send to the online charging system 120 an attribute specific to a certain service catalog and an attribute common to all service catalogs. Hereinafter, operations related thereto will be further described referring to FIG. 5.

In a step 215, the cloud management system 100 receives from the online charging system 120 the quota related to the cloud service, which indicates a limit for the user to use the cloud service. For example, the quota may indicate how long the user may use the cloud service, or the quota may indicate an amount of the cloud service the user may use, such as the amount of the network resources provided by various cloud service layers as described above.

In a step 220, the cloud management system 110 provides the cloud service to the user based on the quota. Therefore, since there is a quota for user's usage of the cloud service, the user's usage charge for the cloud service will not go beyond his expectation and remain within a user-controllable range. If the quota is exhausted, the user may determine whether to continue to use the cloud service in light of own balance, or may use a cloud service with other tariffs, or may stop using cloud services of the cloud system 100.

Apart from the operations and functions described in connection with the method 200, the cloud management system 100 may also implement other optional additional operations and functions. For example, in some embodiments, while the user is using the cloud service, the cloud management system 110 may monitor use status of the cloud service for the user, and send the use status to the online charging system 120. Thereby, the online charging system 120 may calculate the charge for the cloud service used by the user based on the use status, and update the balance in the account of the user based on the calculated charge. Further, the online charging system 120 may real-timely notify the user of balance information, and the cloud management system 110 may obtain the balance information from the online charging system 120 to control the use of the cloud service by the user.

For example, in response to the quota being exhausted, the cloud management system 110 may determine that the user requests for continuing to use the cloud service, and the cloud management system 110 may send to the online charging system 120 a request for an additional quota for the cloud service, in response to requesting for continuing to use the cloud service by the user. In this case, if the user has a sufficient balance in the account, the user may continue to use the cloud service.

Moreover, in response to receiving from the online charging system 120 an indication that the balance in the account of the user is insufficient to continue to use the cloud service, the cloud management system 110 may cease the providing of the cloud service to the user.

In some cases, the user may intend to change a parameter of the cloud service during the use of the cloud service, such as a type, a supply amount, a combining manner, etc., of the cloud service. In these cases, in response to requesting for changing a parameter related to the cloud service by the user, the cloud management system 110 may send a message to the online charging system 120 to instruct the online charging system 120 to reserve a charge for the change in the account of the user.

In response to the parameter of the cloud service being changed, the cloud management system 110 may transmit to the online charging system 120 a message indicating that the parameter has been changed, receive from the online charging system 120 a new quota related to the cloud service with the changed parameter, and provide the cloud service to the user based on the new quota. Thereby, the user may use the cloud service with the changed parameter.

In some cases, the cloud system 100 may not to provide the cloud service with the changed parameter to the user due to, for example, an overload. In these cases, in response to the parameter being unchanged, the cloud management system 110 may transmit to the online charging system 120 a message indicating that the cloud service is not changed, and continue to provide the unchanged cloud service to the user.

In some embodiments, the cloud system 100 may automatically scale a capability of the cloud service provided to the user based on the use status of the cloud service and the overall operation status of the cloud system 100. For example, in the case that the overall load of the cloud system 100 is light and the current capability of the cloud service for the user is low, the cloud system 100 may provide a cloud service of a higher capability to the user, for example, more virtual machines, a larger storage space, etc.

In these embodiments, the cloud management system 110 may transmit to the online charging system 120 a scaling request for scaling a capability of the cloud service based on the load of using the cloud service by the user. Further, the online charging system 120 may determine whether to provide scaling of the cloud service based on the balance in the account of the user, and if the scaling is allowable, the online charging system 120 further determines a new quota related to the scaled cloud service.

In response to receiving from the online charging system 120 a positive response to the scaling request, the cloud management system 110 may scale the capability of the cloud service, receives from the online charging system 120 the new quota related to the scaled cloud service, and provide the scaled cloud service to the user based on the new quota. In response to receiving from the online charging system 120 a negative response to the scaling request, the cloud management system 110 may keep the capability of the cloud service unchanged.

In some embodiments, prior to using the cloud service provided by the cloud system 100, the user may need to perform an operation of on-boarding a service and pay the charge for on-boarding the service. After completing the operation of on-boarding the service, the user may further select various cloud services provided by the cloud system 100. In these embodiments, in response to the service on-boarding request indicating that the user intends to use the cloud system 100, the cloud management system 110 may send an indication of charging an on-boarding charge to the online charging system 120. If a positive response indicating that the on-boarding charge has been charged is received from the online charging system 120, the cloud management system 110 allows the user to use the cloud system 100. If a negative response indicating that the on-boarding charge has not been charged is received from the online charging system 120, the cloud management system 110 declines the user to use the cloud system 100.

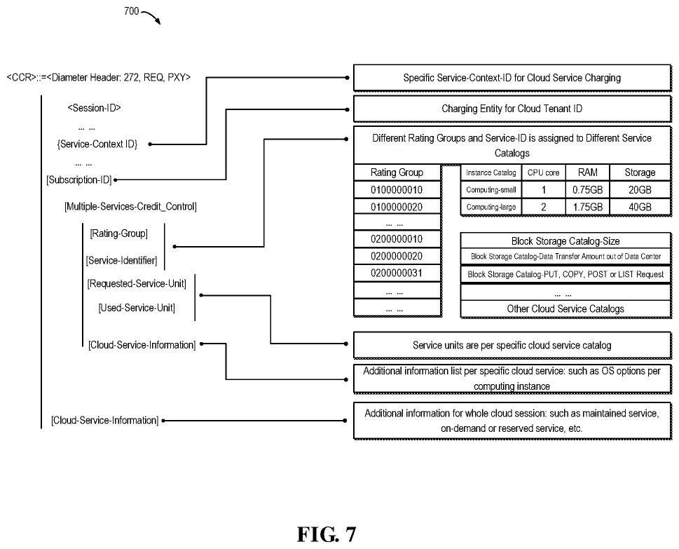

In some embodiments, the cloud service may include at least one of the following service layers: an infrastructure as a service layer, a platform as a service layer, a software as a service layer, or a database as a service layer. In some embodiments, the cloud management system 110 communicates with the online charging system 120 via a DIAMETER online charging interface or an HTTP/XML RESET online charging interface, wherein the DIAMETER protocol is an upgraded version of a RADIUS (Remote Authentication Dial In User Service) protocol, the HTTP refers to Hyper Text Transfer Protocol, the XML refers to Extensive Markup Language, and the REST refers to Representational State Transfer. Hereinafter, operations related thereto will be further described referring to FIG. 7.

FIG. 3 is a flowchart schematically illustrating a method 300 implemented in a cloud system according to another embodiment of the present disclosure. In some embodiments, the method 300 may be performed by the online charging system 120 as depicted in FIG. 1.

The method 300 will be described below mainly referring to the cloud system 100 in FIG. 1. It would be appreciated by those skilled in the art that the method 300 includes corresponding operations to the operations performed by an interactive counterpart that carries out the method 200 as described above in FIG. 2. Therefore, the respective operations of the method 300 may be understood with reference to the description of the method 200. The processes having been described with respect to the method 200 will not be repeated below.

As shown in FIG. 3, in a step 310, the online charging system 120 receives from the cloud management system 110 of the cloud system 100 a message indicating a user and a cloud service. In some embodiments, the cloud service may correspond to at least one service catalog which may have a service price and a service characteristic that may refer to a service type in the service catalog and a supply amount thereof. In the following, operations related to the service catalog according to the embodiments of the present disclosure will be further described in connection with FIG. 4. In the case that the cloud management system 110 communicates with the online charging system 120 based on the service catalog, in the step 310 of the method 300, the online charging system 120 may receive from the cloud management system 110 a service catalog corresponding to the cloud service, and determine a price of the cloud service based on the service price of the service catalog.

In a step 315, the online charging system 120 determines a quota related to the cloud service based on the price of the cloud service and a balance in an account of the user, the quota indicating a limit for the user to use the cloud service. In a step 320, the online charging system 120 transmits the quota to the cloud management system 110. Thereby, the cloud management system 110 provides the cloud service to the user based on the quota.

Apart from these operations and functions as shown in FIG. 3, the online charging system 120 may also implement other optional operations and functions. For example, in some embodiments, while the user is using the cloud service, the online charging system 120 receives from the cloud management system 110 use status of the cloud service for the user, determine a charge for the cloud service used by the user based on the price of the cloud service and the use status, and updates the balance in the account of the user based on the determined charge.

In some embodiments, the online charging system 120 receives from the cloud management system 110 a request for an additional quota for the cloud service, determines the additional quota based on the price of the cloud service and the updated balance in the account of the user, and transmits the additional quota to the cloud management system 110.

In some embodiments, the online charging system 120 transmits to the user the charge and the updated balance in the account. In some embodiments, the online charging system 120 may determine the balance in the account of the user is insufficient for continuing to use the cloud service, and transmit to the cloud management system 110 an indication that the balance in the account of the user is insufficient for continuing to use the cloud service.

In some embodiments, in response to receiving from the cloud management system 110 a message indicating that a charge for changing a parameter related to the cloud service needs to be reserved in the account of the user, the online charging system 120 reserves the charge in the account of the user. In response to receiving from the cloud management system 110 a message indicating that the parameter has been changed, the online charging system 120 deducts the reserved charge from the account of the user, determines a new quota related to the could service with the changed parameter based on a price of the cloud service with the changed parameter and the balance in the account of the user, and sends the new quota to the cloud management system 110. In response to receiving from the cloud management system 110 a message indicating that the cloud service has not been changed, the online charging system 120 returns the reserved charge to the account of the user.

In some embodiments, in response to receiving from the cloud management system 110 a scaling request for scaling a capability of the cloud service, the online charging system 120 determines whether the scaling request is to be approved or declined based on the balance in the account of the user. If the balance in the account of the user is sufficient for the scaling, the online charging system 120 transmits a positive response to the scaling request to the cloud management system 110, determines a new quota related to the scaled cloud service based on a price of the scaled cloud service and the balance in the account of the user, and transmits the new quota to the cloud management system 110. If the balance in the account of the user is insufficient for the scaling, the online charging system 120 transmits a negative response to the scaling request to the cloud management system 110.

In some embodiments, in response to receiving from the cloud management system 110 an indication for charging an on-boarding charge, the online charging system 120 charges the on-boarding charge from the account of the user. If the charging is successful, the online charging system 120 transmits to the cloud management system 110 a positive response indicating that the on-boarding charge has been charged. If the charging is unsuccessful, the online charging system 120 transmits to the cloud management system 110 a negative response indicating that the on-boarding charge has not been charged.

In some embodiments, the online charging system 120 also receives from the cloud management system 110 an attribute specific to a certain service catalog and an attribute common to all service catalogs for use by the online charging system 120 in determination of the price of the cloud service. Besides, the online charging system 120 further determines the price of the cloud service based on at least one of a tariff plan, a bucket usage amount, a bundle price, a counter price, a discount price, a peak hour price or an off-peak hour price. Hereinafter, operations related thereto will be further described referring to FIG. 5.

In some embodiments, the online charge system 120 communicates with the cloud management system 110 via the DIAMETER online charging interface or the HTTP/XML REST online charging interface. Hereinafter, operations related thereto will be further described referring to FIG. 5.

FIG. 4 is a diagram 400 schematically illustrating that the cloud management system 110 and the online charging system 120 operate and interact, with a service catalog, according to embodiments of the present disclosure. It is noted that FIG. 4 only depicts an example without any intention to limit embodiments of the present disclosure in any manner.

As shown in FIG. 4, the cloud management system 110 may provide a cloud service 411 and include a charging trigger module 114. The cloud management system 110 may communicate via an online charging interface 150 with the online charging system 120. The online charging system 120 may provide (460) related charging information to the user device 140. The service delivery and user management and provisioning system 130 may provide (470) a service catalog and service characteristic list 413 to the cloud management system 110 based on the service catalogs, and provide (480) a service catalog and service price list 421 to the online charging system 120 based on the service catalogs. In addition, a list 451 of use status of service catalog for users may be delivered (490) between the cloud management system 110 and the online charging system 120. The service catalogs according to the embodiments of the present disclosure will be described below in detail.

In general, each cloud service includes a plurality of sub-charging items. For example, a cloud storage service can be charged based on a storage size, be charged based on IO requests for accessing storage disks, and be charged based on a data transfer amount in/out of a storage system, etc. In order to better charge for the sub-charging items, the embodiments of the present disclosure introduce a service catalog for each charging item directed to a specific resource, so each cloud service may correspond to a plurality of service catalogs, and different service catalogs define a set of specific service characteristics for the charging trigger module 114 to monitor and control. A service characteristic may refer to a service type in a service catalog and a supply amount thereof. Based on the cloud service catalog the user opted in, the cloud management system 110 may meter and monitor the user's usage of each service catalog via the charging trigger module 114.

To enable the online charging system 120 to real-timely charge for each cloud service catalog, the service catalogs are consistently provisioned between the cloud management system 110 and the online charging system 120, the cloud management system 110 maintains the service characteristic of each service catalog via the list 413, and the online charging system 120 maintains the service price of each service catalog via the list 421. The cloud management system 110 will authorize user's usage of the cloud service and monitor the use status of each opted in cloud service, and report the use status of the cloud service to the online charging system 120 in the form of the list 451 for the online charging system 120 to perform credit/usage charging control.

Further shown in FIG. 4, besides providing a notification to the cloud management system 110, embodiments of the present disclosure also support providing a multi-channel notification to the user to inform the use status of each cloud service catalog and the related charge.

FIG. 5 is a diagram schematically illustrating that the cloud management system 110 transmits information related to the cloud service to the online charging system 120, and the online charging system 120 performs charging based on various factors, according to embodiments of the present disclosure. It is noted that FIG. 5 only depicts an example without any intention to limit the embodiments of the present disclosure in any manner.

As shown in FIG. 5, the cloud management system 110 may send to the online charging system 120, for example, a table 511 related to service catalogs, information 512 related to each service catalog, and information 513 common to all service catalogs (information related to the cloud session). In the example as depicted in FIG. 5, the table 511 includes items such as computing instance size, CPU, memory, instance storage space, I/O performance, etc. The information 512 related to each service catalog includes detailed information related to the operating system, for example, a computing instance catalog including an additional operating system and a software package configuration, etc. The information 513 common to all the service catalogs includes, for example, a data center location, a replicated data center or an independent data center, a managed cloud service with cloud provider support, or an unmanaged cloud service with user self-debugging when some issues happen, etc.

The online charging system 120 may determine a relevant charge for the cloud service used by the user, based on the table 511 related to the service catalogs, the information 512 related to each service catalog, and the information 513 common to all the service catalogs received from the cloud management system 110, and further based on, for example, a (promotional) tariff plan/usage rate 524, bundle/bucket information 525 and discount information 526.

For example, the online charging system 120 may use the reported service catalog 521 to define a tariff plan, a bucket service, a counter price and a discount for a flexible service charging plan. Moreover, the service catalog 521 may be used together with an additional charging criteria and a cloud service characteristic to select various tariff plans defined in the online charging system, for example, in-bundle/out-of-bundle price, usage with peak/off-peak hour discount, etc. Further, besides reporting a usage amount of each cloud service catalog to the online charging system 120, the cloud management system 110, together with the service catalog 521, reports additional service characteristics 522 and 523 to influence the tariff plan, bucket, discount definition, etc.

Alternatively or additionally, each user may have one or more different service options, for example, different numbers of VM instances, different VM instance configurations, different storage sizes, etc. The embodiments of the present disclosure provide a flexible charging report mechanism, and each service catalog can be reported in one charging request, or multiple service catalogs can be combined in one charging request.

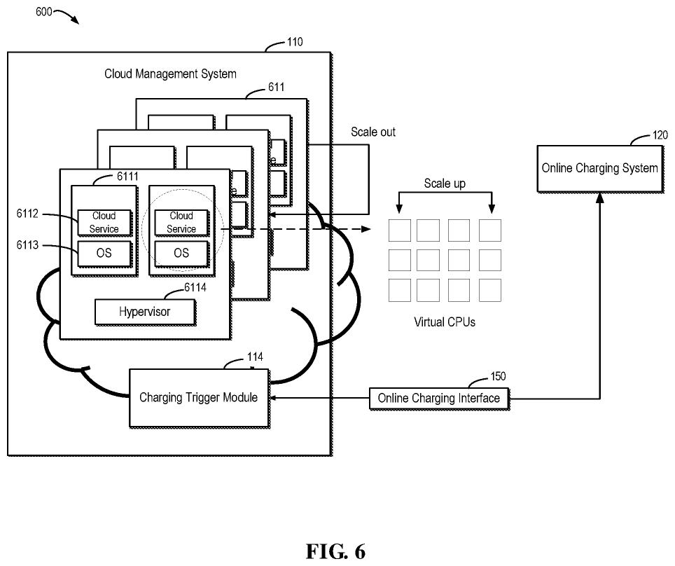

FIG. 6 is a diagram schematically illustrating the cloud management system 110 and the online charging system 120 according to embodiments of the present disclosure in the case of scaling the cloud service. It is noted that FIG. 6 only depicts an example without any intention to limit the embodiments of the present disclosure in any manner.

As shown in FIG. 6, the cloud management system 110 may provide a virtual machine 611. The virtual machine 611 may include a provided specific cloud service 6112 and an operating system 6113. The virtual machine 611 may also include a hypervisor 6114. Besides, the cloud management system 100 may further include charging trigger modules 114. The cloud management system 110 may communicate via the online charging interfaces 150 with the online charging system 120.

Further shown in FIG. 6, the cloud management system 110 can have various scaling mechanisms, for example, scaling up, scaling down, scaling out and scaling in, to adapt the cloud computing need and modify the cloud service characteristic. In the context of the present disclosure, the scaling up and the scaling down mainly refer to scaling up and scaling down of the capability (e.g., virtual CPU) inside the virtual machine 611. The scaling in and the scaling out mainly refer to increase or reduction in the number of the virtual machines 611.

When the service characteristic is changed, the charging trigger modules 114 of the cloud management system 110 may transmit a re-authorization request to the online charging system 120 to determine a granted quota based on a new service characteristic. Therefore, embodiments of the present disclosure may introduce a charging trigger type of the charging trigger modules to monitor and detect changes in the cloud service characteristic during the cloud session.

FIG. 7 is a diagram schematically illustrating an attribute value pair (AVP) in a DIAMETER online charging interface according to embodiments of the present disclosure. It is noted that FIG. 7 only depicts an example without any intention to limit the embodiments of the present disclosure in any manner.

As shown in FIG. 7, the embodiments of the present disclosure provide a DIAMETER online charging interface enhancement for supporting cloud service charging. In the example depicted in FIG. 7, the embodiment of the present disclosure may define for could service charging a unique Service-Context-Identifier, for example, xxx@3gpp.org for could service charging, and the detailed value xxx can be customized based on each user's need.

As indicated by connection lines in FIG. 7, the cloud management system may map a cloud service catalog to an associated rating group and a service identifier to identify each cloud service catalog. In order to accomplish this purpose, a new container group attribute value pair (AVP), Cloud-Service-Information, is defined to extend the current DIAMETER online charging criteria. The characteristics and attributes for cloud service charging may be carried in the Cloud-Service-Information AVP to influence rating and charging. The cloud service information may include a list of sub-AVPs to report characteristics of each specific cloud service type.

In some embodiments of the present disclosure, the cloud service information can be defined at a multiple-service-credit-control (MSCC) level and a DIAMETER command level. For example, the cloud service information at the MSCC level may report the changed characteristics of the cloud service per cloud service catalog. The cloud service information at the DIAMETER command level may report the cloud service charging characteristics occurring in the whole cloud session. Furthermore, the requested service unit, the used service unit, or the granted service unit defined at the MSCC level are reused to carry the quota exchanged between the cloud management system and the online charging system.

It should be appreciated by those skilled in the art that the online charging interface according to the embodiments of the present disclosure is not limited to DIAMETER-based charging. Currently, the telecommunication-based online charging system is mainly based on DIAMETER charging, but considering that the REST-based interface is most popularly adopted by some cloud service management platforms, the embodiments of the present disclosure may also support an HTTP/XML REST online charging interface to support cloud service charging.

The HTTP/XML also provides a flexible mechanism to transfer equivalent cloud service charging information as defined for a DIAMETER online charging interface. The HTTP/XML may also include related cloud service catalog usage, cloud service information of each catalog, and cloud service information at the whole cloud session. Those skilled in the art may implement the HTTP/XML REST online charging interface according to the contents of the present disclosure in view of the relevant technical knowledge. Therefore, the present disclosure will not introduce details of the XML layout. In addition, those skilled in the art may appreciate that the charging requirements of the present disclosure may be achieved by other appropriate protocol interfaces and/or any protocol interfaces currently known or to be developed in the future.

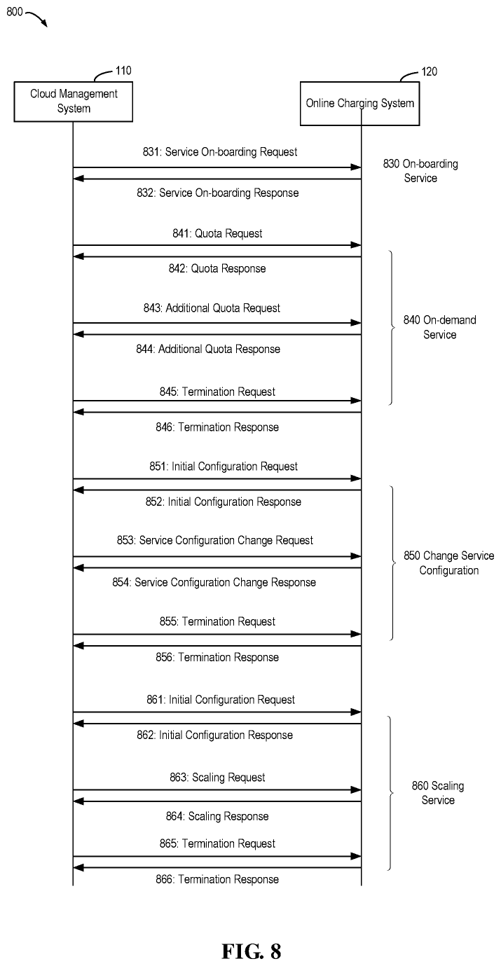

FIG. 8 is an interaction diagram 800 between the cloud management system 110 and the online charging system 120 according to embodiments of the present disclosure. It is noted that FIG. 8 only depicts an example without any intention to limit the embodiments of the present disclosure in any manner.

As mentioned above, the user may intend to use the cloud service, create a cloud account and opt in some cloud services, before the cloud management system 110 provides various requested cloud services. Accordingly, FIG. 8 depicts an operation 830 of on-boarding a service.

In a step 831, the cloud management system 110 may send a request for on-boarding the service to the online charging system 120, and the online charging system 120 may deduct a charge for on-boarding the service from the account of the user. If the balance is sufficient, the cloud service can be on-boarded. If the balance is insufficient to pay the charge, the cloud service cannot be on-boarded for this user. In a step 832, the online charging system 120 may transmit a response to on-boarding the service to the cloud management system 110 accordingly.

Once the cloud service is provided and configured in the cloud management system 110, the user can use the cloud service on demand. FIG. 8 depicts an operation 840 of an on-demand service.

In a step 841, when the user starts to use the cloud service, the cloud management system 110 sends a quota request to the online charging system 120 to determine a quota for the cloud service, for example, how long the user can use the requested cloud service. In a step 842, the online charging system 840 determines the quota for the cloud service based on a cloud service catalog, related cloud service characteristics, a user purchased tariff plan or the like, and returns the allocated quota to the cloud management system 110.

In a step 843, the cloud management system 110 monitors consumption of cloud service resources. Once the allocated quota is exhausted, the cloud management system 110 transmits a request for an additional quota to the online charging system 120 to request more quota if the balance of the user is sufficient for the ongoing cloud session. In a step 844, the online charging system 120 may return the additional quota to the cloud management system 110.

In a step 845, when the user terminates the cloud session, the cloud management system 110 may transmit to the online charging system 120 a termination request to deduct the related usage fees based on the used service units. In a step 846, the online charging system 120 may transmit to the cloud management system 110 a termination response to inform that the charging operation is performed successfully.

As stated above, in some cases, the user may manually change a cloud service configuration. FIG. 8 depicts the operation of changing a service configuration.

In steps 851 and 852, the cloud management system 110 and the online charging system 120 may implement an initial configuration through interaction. In a step 853, before the cloud service can change a configuration, the cloud management system 110 may transmit a service configuration changing request to the online charging system 120 to reserve a charge for such a change.

In a step 854, once the configuration is successfully changed and provisioned, and the services take effect on the cloud management system 110, the online charging system 120 may deduct the configuration change charge from the account of the user. Otherwise, if the configuration is not changed and takes effect, the online charging system 120 cancels and terminates the configuration change, and the reserved charge will be returned to the account of the user. The online charging system 120 transmits a service configuration changing response to the cloud management system 110 accordingly. In steps 855 and 856, the cloud management system 110 and the online charging system 120 may terminate the cloud service through interaction.

As stated above, in some cases, once the cloud service is provisioned and configured in the cloud management system 110, the user may also set the cloud system to perform an automatic scaling service for an on-going cloud session. FIG. 8 depicts an operation 860 of the scaling service.

In steps 861 and 862, the cloud management system 110 and the online charging system 120 may implement an initial configuration of the cloud service through interaction. In a step 863, when the user is consuming the cloud service quota, the cloud management system 110 may monitor a change in the cloud service resource configuration. Once the cloud service usage load is changed, the cloud management system 110 may automatically perform one or more of scaling up, scaling down, scaling in, or scaling out to adapt to a new service load. The cloud management system 110 may request the online charging system 120 to re-authorize the service quota based on the cloud service characteristics, and re-allocate a quota for the cloud service. If the balance of the end user is insufficient to scale the cloud service, the online charging system 120 may return a related result to the cloud management system 110 to decline the scaling operation, and the cloud service may continue based on the current configuration capability.

In a step 864, the online charging system 120 sends a scaling response responsively to the cloud management system 110. In steps 865 and 866, the cloud management system 110 and the online charging system 120 may terminate the cloud service through interaction.

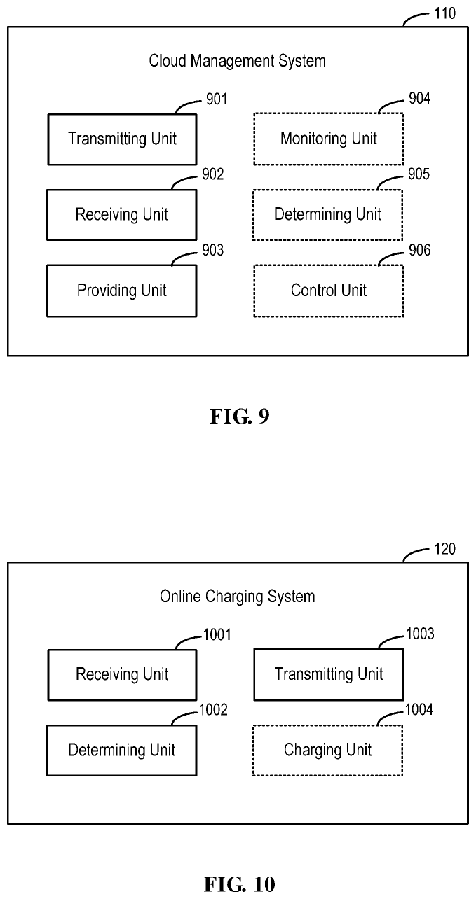

FIG. 9 is a block diagram schematically illustrating the cloud management system 110 of a cloud system according to embodiments of the present disclosure. Those skilled in the art may appreciate that FIG. 9 only shows units or components closely related to the present disclosure in the cloud management system 110, and in a specific implementation, the cloud management system 110 may also include other functional units or components enabling normal operation thereof. Besides, there may be necessary connections between various units or components as shown in FIG. 9, but FIG. 9 does not depict these connections for brevity. In FIG. 9, dotted blocks are used to represent optional units or components. In some embodiments, the cloud management system 110 may be configured to perform the method 200 implemented in the cloud system as described above with reference to FIG. 2.

As shown in FIG. 9, the cloud management system 110 includes a transmitting unit 901, a receiving unit 902, and a providing unit 903. The transmitting unit 901 is configured to send a message indicating a user and a cloud service to an online charging system of the cloud system in response to a request for the cloud service in the cloud system from the user. The receiving unit 902 is configured to receive from the online charging system a quota related to the cloud service, the quota indicating a limit for the user to use the cloud service. The providing unit 903 is configured to provide the cloud service to the user based on the quota.

In some embodiments, the cloud management system 110 may further include a monitoring unit 904. The monitoring unit 904 is configured to monitor the use status of the cloud service for the user while the user is using the cloud service, and the transmitting unit 901 may be further configured to transmit the use status to the online charging system.

In some embodiments, the cloud management system 110 may further include a determining unit 905. The determining unit 905 is configured to determine that the user requests for continuing to use the cloud service in response to the quota being exhausted, and the transmitting unit 901 may be further configured to transmit a request for an additional quota for the cloud service to the online charging system in response to requesting for continuing to use the cloud service by the user.

In some embodiments, the providing unit 903 may be further configured to cease the providing of the cloud service to the user, in response to the receiving unit 902 receiving from the online charging system an indication that a balance in an account of the user is insufficient for continuing to use the cloud service.

In some embodiments, the transmitting unit 901 may be further configured to, in response to requesting for changing a parameter related to the cloud service by the user, transmit to the online charging system a message to instruct the online charging system to reserve a charge for the change in the account of the user.

In some embodiments, in response to the cloud service parameter being changed, the transmitting unit 901 may be further configured to transmit to the online charging system a message indicating that the parameter has been changed, the receiving unit 902 may be further configured to receive from the online charging system a new quota related to the cloud service with the changed parameter, and the providing unit 903 may be further configured to provide the cloud service to the user based on the new quota.

In some embodiments, in response to the parameter being unchanged, the transmitting unit 901 may be further configured to transmit to the online charging system a message indicating that the cloud service is unchanged, and the providing unit 903 may be further configured to continue providing the unchanged cloud service to the user.

In some embodiments, the transmitting unit 901 may be further configured to transmit to the online charging system a scaling request for scaling a capability of the cloud service, based on a load of using the cloud service by the user, the providing unit 903 may be further configured to scale the capability of the cloud service in response to the receiving unit 902 receiving from the online charging system a positive response to the scaling request, the receiving unit 902 may be further configured to receive from the online charging system a new quota related to the scaled cloud service, and the providing unit 903 may be further configured to provide the scaled cloud service to the user based on the new quota.

In some embodiments, the providing unit 903 may be further configured to maintain the capability of the cloud service unchanged, in response to the receiving unit 902 receiving from the online charging system a negative response to the scaling request.

In some embodiments, the transmitting unit 901 may be further configured to transmit to the online charging system an indication of charging an on-boarding charge in response to a service on-boarding request indicating that the user intends to use the cloud service, and the cloud management system 110 may further include a control unit 906. If the receiving unit 902 receives from the online charging system a positive response indicating that the on-boarding charge has been charged, the control unit 906 allows the user to use the cloud service, and if the receiving unit 902 receives from the online charging system a negative response indicating that the on-boarding charge has not been charged, the control unit 906 declines the user to use the cloud system.

In some embodiments, the cloud service may correspond to at least one service catalog, the service catalog may include a service characteristic and a service price, and the service characteristic may refer to at least one service type in the service catalog and a supply amount thereof.

In some embodiments, the transmitting unit 901 may be further configured to transmit a service catalog corresponding to the cloud service to the online charging system.

In some embodiments, the transmitting unit 901 may be further configured to transmit to the online charging system an attribute specific to a certain service catalog and an attribute common to all service catalogs.

In some embodiments, the cloud service may include at least one of the following service layers: an infrastructure as a service layer, a platform as a service layer, a software as a service layer, or a database as a service layer.

In some embodiments, the transmitting unit 901 and the receiving unit 902 may be configured to communicate with the online charging system via a DIAMETER online charging interface or an HTTP/XML REST online charging interface.

FIG. 10 is a block diagram schematically illustrating the online charging system 120 of the cloud system according to embodiments of the present disclosure. Those skilled in the art may appreciate that FIG. 10 only shows units or components closely related to the present disclosure in the online charging system 120, and in a specific implementation, the online charging system 120 may also include other functional units or components enabling normal operation thereof. Besides, there may be necessary connections between units or components as shown in FIG. 10, but FIG. 10 does not depict these connections for brevity. In FIG. 10, dotted blocks are used to represent optional units or components. In some embodiments, the online charging system 120 may be configured to perform the method 300 implemented at the cloud system as described above with reference to FIG. 3.

As shown in FIG. 10, the online charging system 120 includes a receiving unit 1001, a determining unit 1002 and a transmitting unit 1003. The receiving unit 1001 is configured to receive a message indicating a user and a cloud service from the cloud management system of the cloud system. The determining unit 1002 is configured to determine a quota related to the cloud service based on a price of the cloud service and a balance in an account of the user, the quota indicating a limit for the user to use the cloud service. The transmitting unit 1003 is configured to transmit the quota to the cloud management system.

In some embodiments, the receiving unit 1001 may be further configured to receive from the cloud management system use status of the cloud service for the user while the user is using the cloud service. The online charging system 120 may be further include a charging unit 1104 configured to determine a charge for the cloud service used by the user based on the price of the cloud service and the use status, and update the balance in the account of the user based on the determined charge.

In some embodiments, the receiving unit 1001 may be further configured to receive from the cloud management system a request for an additional quota for the cloud service, the determining unit 1002 may be further configured to determine the additional quota based on the price of the cloud service and the updated balance in the account of the user, and the transmitting unit 1003 may be further configured to transmit the additional quota to the cloud management system.

In some embodiments, the transmitting unit 1003 may be further configured to transmit the charge and the updated balance in the account to the user.

In some embodiments, the determining unit 1002 may be further configured to determine that the balance in the account of the user is insufficient for continuing to use the cloud service, and the transmitting unit 1003 may be further configured to transmit to the cloud management system an indication that the balance in the account of the user is insufficient for continuing to use the cloud service.

In some embodiments, the charging unit 1104 may be further configured to, in response to the receiving unit 1001 receiving from the cloud management system a message indicating that a charge for changing a parameter related to the cloud service need to be reserved in the account of the user, reserve the charge in the account of the user.

In some embodiments, the charging unit 1104 may be further configured to deduct the reserved charge from the account of the user in response to the receiving unit 1001 receiving from the cloud management system a message indicating that the parameter has been changed, the determining unit 1002 may be further configured to determine a new quota related to the cloud service with the changed parameter based on a price of the cloud service with the changed parameter and the balance in the account of the user, and the transmitting unit 1003 may be further configured to transmit the new quota to the cloud management system.

In some embodiments, the charging unit 1104 may be further configured to return the reserved charge to the account of the user in response to the receiving unit 1001 receiving from the cloud management system a message indicating that the cloud service has not been changed.

In some embodiments, the determining unit 1002 may be further configured to, in response to the receiving unit 1001 receiving from the cloud management system a scaling request for scaling a capability of the cloud service, determine whether the scaling request is to be approved or declined based on the balance in the account of the user. If the balance in the account of the user is sufficient for the scaling, the transmitting unit 1003 may be further configured to transmit a positive response to the scaling request to the cloud management system, the determining unit 1002 may be further configured to determine a new quota related to the scaled cloud service based on a price of the scaled cloud service and the balance in the account of the user, and the transmitting unit 1003 may be further configured to transmit the new quota to the cloud management system.

In some embodiments, if the balance in the account of the user is insufficient for the scaling, the transmitting unit 1003 may be further configured to transmit a negative response to the scaling request to the cloud management system.

In some embodiments, the charging unit 1104 may be further configured to, in response to the receiving unit 1004 receiving from the cloud management system an indication of charging an on-boarding charge, charge the on-boarding charge from the account of the user. If the charging is successful, the transmitting unit 1003 may be further configured to transmit to the cloud management system a positive response indicating that the on-boarding charge has been charged, and if the charging is unsuccessful, the transmitting unit 1003 may be further configured to send to the cloud management system a negative response indicating that the on-boarding charge has not been charged.

In some embodiments, the cloud service may correspond to at least one service catalog, the service catalog may include a service characteristic and a service price, and the service characteristic may refer to a service type in the service catalog and a supply amount thereof.

In some embodiments, the receiving unit 1001 may be further configured to receive a service catalog corresponding to the cloud service from the cloud management system, and the determining unit 1002 may be further configured to determine a price of the cloud service based on the service price of the service catalog.

In some embodiments, the receiving unit 1001 may be further configured to receive from the cloud management system an attribute specific to a certain service catalog and an attribute common to all the service catalogs, for the determining unit 1002 using in determination of the price of the cloud service.

In some embodiments, the determining unit 1002 may be further configured to determine the price of the cloud service based on at least one of a tariff plan, a bucket usage amount, a bundle price, a counter price, a discount price, a peak hour price or an off-peak hour price.

In some embodiments, the cloud service may include at least one of the following service layers: an infrastructure as a service layer, a platform as a service layer, a software as a service layer, or a database as a service layer.

In some embodiments, the transmitting unit 1003 and the receiving unit 1001 may be configured to communicate with the online charging system via a DIAMETER online charging interface or an HTTP/XML REST online charging interface.

The embodiments of the present disclosure provide an online charging and offline charging solution for any cloud-based service at any layer (e.g. IaaS, PaaS, SaaS, DBaaS, etc.). The embodiments of the present disclosure provide a cloud service catalog management function, which maintains service characteristics related to each cloud service product catalog provided to a user and a related price plan.

When the user opts in the related cloud service, a related user profile is provided together with the opt-in price plan to the online charging system, and the related service catalog with the related characteristic is provided to the cloud management system to set up a cloud resource for these services.

In some embodiments of the present disclosure, charging trigger modules are introduced into the cloud management system. When the user starts to use the provided cloud service, the charging trigger modules will trigger transmitting of a charging request from the cloud management system to the online charging system to authorize use of the cloud service, and the online charging system will return the allocated quota to the cloud management system.

The embodiments of the present disclosure introduce online charging interfaces between the cloud management system and the online charging system, and the cloud management system reports usage of the cloud service to the online charging system for performing credit control and usage authorization.

The embodiments of the present disclosure enable the cloud management system to report use status of multiple cloud services during one cloud session. Besides reporting the use status of each cloud service catalog, the embodiments of the present disclosure also enable the cloud management system to report additional cloud service characteristics at a specific cloud service level and at a cloud session level

The embodiments of the present disclosure also provide a new trigger type, enabling the online charging system to monitor a change in a cloud service resource due to scaling the cloud service resource/configuration during the cloud session. The online charging system will use a new cloud service characteristic to re-authorize the quota for the cloud service. The embodiments of the present disclosure further enable an operator to extend the current telecommunication-based online charging solutions to an Internet Technology based cloud service charging field.

As used herein, the term “includes” and its variants are to be read as open-ended terms that mean “includes, but is not limited to.” The term “based on” is to be read as “based at least in part on.” The term “one example embodiment” and “the example embodiment” are to be read as “at least one example embodiment.”

It will be noted that the embodiments of the present disclosure can be implemented in software, hardware, or a combination thereof. The hardware part can be implemented by a special logic; the software part can be stored in a memory and executed by a suitable instruction execution system such as a microprocessor or special purpose hardware. Those skilled in the art may understand that the above apparatus and method may be implemented with computer executable instructions and/or in processor-controlled code, for example, such code is provided on a programmable memory, or a data bearer such as an optical or electronic signal bearer.

Further, although operations of the present methods are described in a particular order in the drawings, it does not require or imply that these operations are necessarily performed according to this particular sequence, or a desired outcome can only be achieved by performing all shown operations. On the contrary, the execution order for the steps as depicted in the flowcharts may be varied. Alternatively, or in addition, some steps may be omitted, a plurality of steps may be merged into one step, or a step may be divided into a plurality of steps for execution. It should also be noted that, the features and functions of two or more units described above may be embodied in one unit. In turn, the features and functions of one unit described above may be further embodied in more units.

Although the present disclosure has been described with reference to various embodiments, it should be understood that the present disclosure is not limited to the disclosed embodiments. The present disclosure is intended to cover various modifications and equivalent arrangements included in the spirit and scope of the appended claims.

1. A method implemented in a cloud system, comprising:
in response to a request for a cloud service in the cloud system from a user, transmitting to an online charging system of the cloud system a message indicating the user and the cloud service;
receiving from the online charging system a quota related to the cloud service, the quota indicating a limit for the user to use the cloud service; and
providing the cloud service to the user based on the quota.

2. The method according to claim 1, further comprising:
monitoring use status of the cloud service for the user while the user is using the cloud service; and
transmitting the use status to the online charging system.

3. The method according to claim 1, further comprising:
in response to the quota being exhausted, determining that the user requests for continuing to use the cloud service; and
in response to determining that the user requests for continuing to use the cloud service, transmitting to the online charging system a request for an additional quota for the cloud service.

4. (canceled)

5. The method according to claim 1, further comprising:
in response to requesting for changing a parameter related to the cloud service by the user, transmitting a message to the online charging system to instruct the online charging system to reserve a charge for the change in an account of the user.

6. The method according to claim 5, further comprising:
in response to the parameter related to the cloud service being changed, transmitting to the online charging system a message indicating that the parameter has been changed;
receiving from the online charging system a new quota related to the cloud service with the changed parameter; and
providing the cloud service to the user based on the new quota.

7. (canceled)

8. The method according to claim 1, further comprising:
transmitting to the online charging system, based on a load of using the cloud service by the user, a scaling request for scaling a capability of the cloud service;
in response to receiving from the online charging system a positive response to the scaling request,
scaling the capability of the cloud service;
receiving from the online charging system a new quota related to the scaled cloud service; and
providing the scaled cloud service to the user based on the new quota.

9.-15. (canceled)

16. A method implemented in a cloud system, comprising:
receiving from a cloud management system of the cloud system a message indicating a user and a cloud service;
determining a quota related to the cloud service based on a price of the cloud service and a balance in an account of the user, the quota indicating a limit for the user to use the cloud service; and
transmitting the quota to the cloud management system.

17. The method according to claim 16, further comprising:
receiving from the cloud management system use status of the cloud service for the user while the user is using the cloud service;
determining a charge for the cloud service used by the user based on the price of the cloud service and the use status; and
updating the balance in the account of the user based on the determined charge.

18. The method according to claim 17, further comprising:
receiving from the cloud management system a request for an additional quota for the cloud service;
determining the additional quota based on the price of the cloud service and the updated balance in the account of the user; and
transmitting the additional quota to the cloud management system.

19.-20. (canceled)

21. The method according to claim 16, further comprising:
in response to receiving from the cloud management system a message indicating that a charge for changing a parameter related to the cloud service is to be reserved in an account of the user, reserving the charge in the account of the user.

22.-23. (canceled)

24. The method according to claim 16, further comprising:
in response to receiving from the cloud management system a scaling request for scaling a capability of the cloud service, determining whether the scaling request is approved or declined based on the balance in the account of the user;
if the balance in the account of the user is sufficient for the scaling,
transmitting to the cloud management system a positive response to the scaling request;
determining a new quota related to the scaled cloud service based on a price of the scaled cloud service and the balance in the account of the user; and
transmitting the new quota to the cloud management system.

25. The method according to claim 24, further comprising:
if the balance in the account of the user is insufficient for the scaling, transmitting to the cloud management system a negative response to the scaling request.

26.-35. (canceled)

36. A cloud management system of a cloud system, comprising:
a memory; and
a processor, the memory being configured with the processor to cause the cloud management system to perform the method according to claim 1.

37. An online charging system of a cloud system, comprising:
a memory; and
a processor, the memory being configured with the processor to cause the online charging system to perform the method according to claim 16.
